(19) United States
(12) Patent Application Publication
(10) Pub. No.: US 2021/0089208 A1
(43) Pub. Date: Mar. 25, 2021

(54) MEMORY SYSTEM AND DATA PROCESSING SYSTEM INCLUDING THE SAME

(71) Applicant: SK hynix inc., Icheon (KR)

(72) Inventors: Yong JIN, Icheon (KR); Seung Won JEON, Icheon (KR)

(21) Appl. No.: 16/877,239

(22) Filed: May 18, 2020

(30) Foreign Application Priority Data
Sep. 24, 2019 (KR) 10-2019-0117406

(51) Int. Cl. G06F 3/06

(52) U.S. Cl. CPC G06F 3/064; G06F 3/0629; G06F 3/0688; G06F 3/0659; G06F 3/061; G06F 3/0658

(57) ABSTRACT

A memory system includes a storage medium including a plurality of nonvolatile memory devices grouped into a plurality of groups and a controller configured to manage the storage medium by a unit of a zone block, the controller selecting one nonvolatile memory device from each of the groups and configuring the zone block over the selected nonvolatile memory devices.

### CROSS-REFERENCES TO RELATED APPLICATION

The present application claims priority under 35 U.S.C. § 119(a) to Korean application number 10-2019-0117406, filed on Sep. 24, 2019, in the Korean Intellectual Property Office, which is incorporated herein by reference in its entirety.

### BACKGROUND

### 1. Technical Field

Various embodiments generally relate to a memory system, and more particularly, to a memory system including a nonvolatile memory device.

### 2. Related Art

A memory system may be configured to store, in response to a write request from a host device, data provided from the host device. Also, the memory system may be configured to provide, in response to a read request from the host device, data stored therein to the host device. The host device may be an electronic device capable of processing data and may include a computer, a digital camera, a mobile phone and so forth. The memory system may be provided within the host device or may be manufactured as detachable from the host device. The memory system may be operable when coupled to the host device.

### SUMMARY

Various embodiment of the present disclosure provides a memory system having improved write performance and a data processing system including the same.

In accordance with an embodiment of the present disclosure, a memory system may include a storage medium and a controller. The storage medium may include a plurality of nonvolatile memory devices grouped into a plurality of groups. The controller may manage the storage medium by a unit of a zone block. The controller may select one nonvolatile memory device from each of the groups and configure the zone block over the selected nonvolatile memory devices.

In accordance with an embodiment of the present disclosure, a memory system may include a storage medium and a controller. The storage medium may include a plurality of nonvolatile memory devices. The plurality of nonvolatile memory device may include first and second nonvolatile memory devices respectively coupled to first and second input/output lines that are different from one another. The controller may manage the storage medium by a unit of a zone block. Each zone block of a plurality of zone blocks may be configured over each of the first and second nonvolatile memory devices. The controller may perform a plurality of write operations respectively corresponding to the plurality of zone blocks at the same time.

In accordance with an embodiment of the present disclosure, a data processing system may include a memory system and a host device. The memory system may include a storage medium and a controller. The host device may designate a zone block within the storage medium and provide a write request including information of the zone block to the controller. The controller may write data into the zone block according to the write request.

In accordance with an embodiment of the present disclosure, provided is the memory system having improved write performance and the data processing system including the same.

### BRIEF DESCRIPTION OF THE DRAWINGS

Features, aspects and embodiments are described in conjunction with the attached drawings, in which:

FIG. 1 illustrates a memory system in accordance with an embodiment;

FIG. 2 illustrates start write pointers of zone blocks in accordance with an embodiment;

FIGS. 3A and 3B illustrate improvement of write performance in accordance with an embodiment; and

FIG. 4 illustrates a data processing system in accordance with an embodiment.

FIG. 5 illustrates a data processing system including a solid state drive (SSD) in accordance with an embodiment.

FIG. 6 illustrates a data processing system including a memory system in accordance with an embodiment.

FIG. 7 illustrates a data processing system including a memory system in accordance with an embodiment.

FIG. 8 illustrates a network system including a memory system in accordance with an embodiment.

FIG. 9 illustrates a nonvolatile memory device included in a memory system in accordance with an embodiment.

### DETAILED DESCRIPTION

Illustrative embodiments of the present disclosure will be described below in more detail with reference to the accompanying drawings. However, embodiments may be in different forms and should not be construed as limited to the embodiments set forth herein. Rather, these embodiments are provided so that this disclosure will be thorough and complete, and will fully convey the scope of the present disclosure to those skilled in the art.

The drawings are not necessarily to scale and, in some instances, proportions may have been exaggerated in order to clearly illustrate features of the embodiments. The terminology used herein for the purpose of describing particular embodiments only and is not intended to be limiting.

As used herein, the term “and/or” includes at least one of the associated listed items. It will be understood that when an element is referred to as being “connected to”, or “coupled to” another element, it may be directly on, connected to, or coupled to the other element, or one or more intervening elements may be present. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements and do not preclude the presence or addition of one or more other elements.

Hereinafter, illustrative embodiments of the present disclosure will be described below with reference to the accompanying drawings.

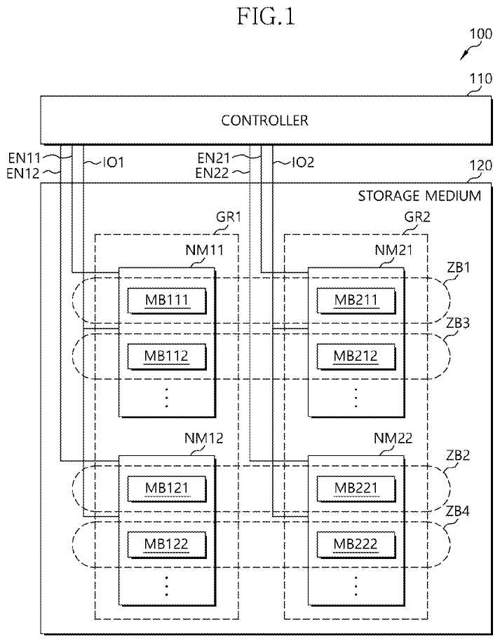

FIG. 1 illustrates a memory system 100 in accordance with an embodiment.

The memory system 100 may be configured to store, in response to a write request from a host device (not illustrated), data provided from the host device. Also, the memory system 100 may be configured to provide, in response to a read request from the host device, data stored therein to the host device.

The memory system 100 may be configured as a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), a Solid State Drive (SSD), or the like.

The memory system 100 may include a controller 110 and a storage medium 120.

The controller 110 may control a general operation of the memory system 100. The controller 110 may control the storage medium 120 in order to perform a foreground operation in response to a request from the host device. A foreground operation may include an operation of writing data in the storage medium 120 or of reading data from the storage medium 120 in response to a request (e.g., a write request or a read request) from the host device.

The controller 110 may control the storage medium 120 in order to perform a background operation internally necessary and independent of the host device. The background operation may include a wear leveling operation, a garbage collection operation, an erase operation, a read reclaim operation, a refresh operation and so forth on the storage medium 120. Like the foreground operation, the background operation may include an operation of writing data in the storage medium 120 and reading data from the storage medium 120.

The storage medium 120 may store therein data transferred from the controller 110 under the control of the controller 110. The storage medium 120 may read data therefrom and provide the read data to the controller 110 under the control of the controller 110.

The storage medium 120 may include nonvolatile memory devices NM11, NM12, NM21 and NM22.

Each of the nonvolatile memory devices NM11, NM12, NM21 and NM22 may include a flash memory such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), or the like.

Each of the nonvolatile memory devices NM11, NM12, NM21 and NM22 may include one or more planes, one or more memory chips, one or more memory dies or one or more memory packages.

The nonvolatile memory devices NM11, NM12, NM21 and NM22 may be grouped into first and second groups GR1 and GR2. Nonvolatile memory devices included in the same group may be coupled to the controller 110 through the same input/output lines. For example, the first group GR1 may include the nonvolatile memory devices NM11 and NM12 coupled to the controller 110 through a first input/output line IO1, and the second group GR2 may include the nonvolatile memory devices NM21 and NM22 coupled to the controller 110 through a second input/output line IO2. While the first input/output line IO1 and the second input/output line IO2 are described herein as single lines, embodiments are not limited thereto, and in embodiments nonvolatile memory devices in the first group GR1 are coupled to the controller 110 through a first plurality of input/output lines and nonvolatile memory devices in the second group GR2 are coupled to the controller 110 through a second plurality of input/output lines different from the first plurality of input/output lines.

The first input/output line IO1 may transfer a first command, a first address and/or first data between the controller 110 and the nonvolatile memory devices NM11 and NM12 within the first group GR1 at the same time as the second input/output line IO2 may transfer a second command, a second address and/or second data between the controller 110 and the nonvolatile memory devices NM21 and NM22 within the second group GR2.

The nonvolatile memory devices NM11, NM12, NM21 and NM22 may be coupled to the controller 110 through enable lines EN11, EN12, EN21 and EN22, respectively. Therefore, even when the nonvolatile memory devices NM11 and NM12 or the nonvolatile memory devices NM21 and NM22 within the same group shares an input/output line of the input/output line IO1 and the input/output line IO2, the controller 110 may selectively access, by selecting or enabling an enable line among the enable lines EN11, EN12, EN21 and EN22, a corresponding nonvolatile memory device among the nonvolatile memory devices NM11 and NM12 or the nonvolatile memory devices NM21 and NM22.

Each of the nonvolatile memory devices NM11, NM12, NM21 and NM22 may include a plurality of memory blocks. A memory block may be a unit of memory on which a nonvolatile memory device performs an erase operation at a time. However, the memory block will not be limited thereto and the nonvolatile memory device may perform an erase operation on a different unit at a time.

A number of nonvolatile memory devices included in the storage medium 120, a number of the groups, and a number of nonvolatile memory device included in each group are not limited to the numbers described with reference to FIG. 1.

In accordance with an embodiment, the controller 110 may manage the storage medium 120 by units of zone blocks. The controller 110 may configure one or more zone blocks within the storage medium 120 and may manage the zone blocks. The controller 110 may manage the zone blocks by assigning a number or an address to each of the zone blocks. In response to a request of a host device, the controller 110 may store data into a zone block designated by the host device or may read data from a zone block to provide the read data to the host device.

In accordance with an embodiment, the controller 110 may select one nonvolatile memory device from each group to provide the physical storage for each zone block. Since the controller 110 selects one nonvolatile memory device from each group within the storage medium 120 when configuring the zone blocks, independency of each group may be provided within the respective zone blocks. For example, the controller 110 may configure zone blocks ZB1 to ZB4 within the storage medium 120. The zone blocks ZB1 and ZB3 may each be configured to use the nonvolatile memory device NM11 from the first group GR1 and the nonvolatile memory device NM21 from the second group GR2. The zone blocks ZB2 and ZB4 may each be configured to use the nonvolatile memory device NM12 from the first group GR1 and the nonvolatile memory device NM22 from the second group GR2.

In accordance with an embodiment, the controller 110 may select, in order to configure the zone blocks ZB1 to ZB4, the nonvolatile memory devices coupled to the enable lines of the same ordering within the respective groups GR1 and GR2 of the storage medium 120. For example, the enable lines EN11 and EN21 may be of the same ordering within the respective groups GR1 and GR2, and the enable lines EN12 and EN22 may be of the same ordering within the respective groups GR1 and GR2. In this case, the controller 110 may select, in order to configure the zone blocks ZB1 and ZB3, the nonvolatile memory devices NM11 and NM21 coupled to the enable lines EN11 and EN21 of the same ordering within the respective groups GR1 and GR2. Also, the controller 110 may select, in order to configure the zone blocks ZB2 and ZB4, the nonvolatile memory devices NM12 and NM22 coupled to the enable lines EN12 and EN22 of the same ordering within the respective groups GR1 and GR2.

In accordance with an embodiment, each of the zone blocks ZB1 to ZB4 may be configured to include memory blocks having the same block address within the nonvolatile memory devices they are configured to use. For example, the zone block ZB1 may include the memory block MB111 having a block address ‘B’ within the nonvolatile memory device NM11 and the memory block MB211 having the same block address ‘B’ within the nonvolatile memory device NM21. A block address may be a physical or local address distinguishing memory blocks within a nonvolatile memory device.

Although FIG. 1 illustrates a zone block including one memory block from each nonvolatile memory device that the zone block uses, embodiments are note limited thereto. Each of the nonvolatile memory devices NM11, NM12, NM21 and NM22 may include a plurality of memory blocks having the same plurality of respective block addresses. In this case, each zone block may be configured by selecting the plurality of memory blocks having the same respective block addresses from each of the nonvolatile memory devices that the zone block is configured to use.

Although FIG. 1 illustrates the two groups GR1 and GR2 within the storage medium 120, embodiments are not limited thereto. The storage medium 120 may include two or more groups. When the storage medium 120 includes two or more groups, each zone block may be configured to use nonvolatile memory devices from only some of the groups among the whole groups. For example, when the storage medium 120 includes first to fourth groups, one zone block may be configured to use nonvolatile memory devices selected from the first and second groups and another zone block may be configured to use nonvolatile memory devices selected from the third and fourth groups.

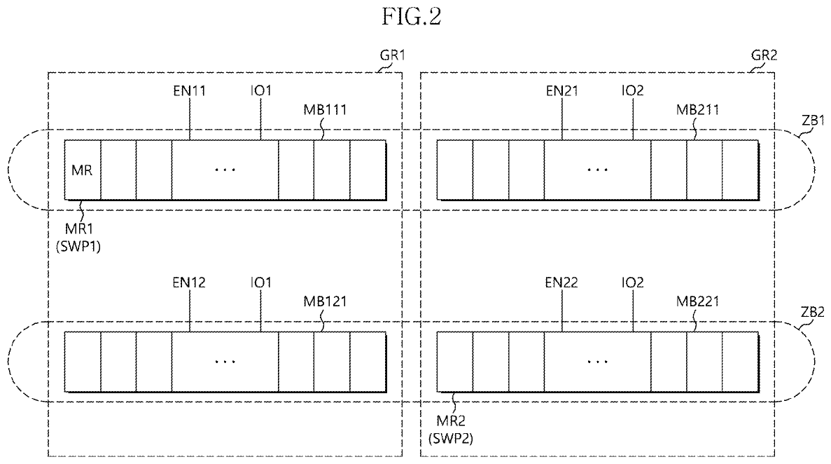

In accordance with an embodiment, the controller 110 may perform, when initially writing data into a plurality of empty zone blocks, write operations at the same time (or substantially the same time) on two or more of the zone blocks. The controller 110 may start performing the write operations at the same time by providing respective data at the same time to at least some of the zone blocks. As described in detail with reference to FIG. 2, two or more start write pointers of the zone blocks may indicate different groups from one another.

FIG. 2 is a diagram illustrating first and second start write pointers SWP1 and SWP2 of zone blocks ZB1 and ZB2 in accordance with an embodiment.

Referring to FIG. 2, the first zone block ZB1 may include the memory blocks MB111 and MB211 and the second zone block ZB2 may include the memory blocks MB121 and MB221.

Each memory block may include a plurality of memory regions MR. A memory region MR may be a unit of memory on which s a nonvolatile memory device performs a write operation or a read operation at a time, such as a page. However, the memory region MR will not be limited thereto and the nonvolatile memory device may perform a write operation or a read operation on a different unit at a time. In FIG. 2, memory blocks MB111, MB211, MB121, and MB221 respectively correspond to the like numbered memory blocks of the nonvolatile memory devices NM11, NM12, NM21 and NM22 of FIG. 1, over which the first zone block ZB1 and the second zone block ZB2 are configured.

The first start write pointer SWP1 of the first zone block ZB1 may indicate a first memory region MR1 into which data is initially written within the first zone block ZB1. That is, when data is initially written into the first zone block ZB1 that is empty, the controller 110 may perform a write operation on the first memory region MR1.

The second start write pointer SWP2 of the second zone block ZB2 may indicate a second memory region MR2, into which data is initially written within the second zone block ZB2. That is, when data is initially written into the second zone block ZB2 that is empty, the controller 110 may perform a write operation on the second memory region MR2.

The first start write pointer SWP1 and the second start write pointer SWP2 may be set to indicate the first memory region MR1 and the second memory region MR2 within the different groups; here, the first memory region MR1 is in the first group GR1 and the second memory region MR2 is in the second group GR2. In other words, the first start write pointer SWP1 may be set to indicate the first memory region MR1 in a nonvolatile memory device coupled to the first input/output line IO1 and the second start write pointer SWP2 may be set to indicate the memory region MR2 in a nonvolatile memory device coupled to the second input/output line IO2, where the first and second input/output lines IO1 and IO2 are different from each other.

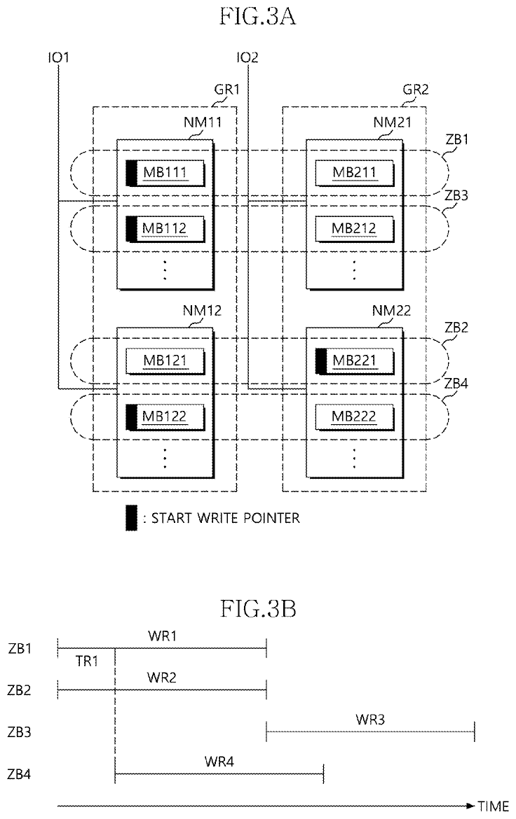

As a result, the initial write operations on the first zone block ZB1 and the second zone block ZB2 that are empty, that is, the write operations on the first memory region MR1 and the second memory region MR2, may be performed at the same time. That is, the controller 110 may start the respective write operations on the first memory region MR1 and the second memory region MR2 at the same time by providing respective data at the same time to the first input/output line IO1 and the second input/output line IO2, which are different from each other. More generally, while the first start write pointer SWP1 of the first zone block ZB1 and the second write pointer SWP2 of the second zone block ZB2 respectively indicate memory regions in different groups, data and command transmissions of respective write operations to the first zone block ZB1 and the second zone block ZB2 may overlap in time. Therefore, as described in detail with reference to FIGS. 3A and 3B, the write performance of the memory system 100 may be improved.

FIGS. 3A and 3B are diagrams for describing improvement of write performance in accordance with an embodiment.

FIG. 3A illustrates the memory regions indicated by the start write pointers of the zone blocks ZB1 to ZB4, respectively. For example, the start write pointers of the zone blocks ZB1, ZB3 and ZB4 may indicate memory regions in the first group GR1 and thus may indicate memory regions MR of the memory blocks MB111, MB112 and MB122, which are coupled to the first input/output line IO1. On the other hand, the start write pointer of the zone block ZB2 may indicate memory regions in the second group GR2 and thus may indicate memory region MR of the memory block MB221, which is coupled to the second input/output line IO2.

FIG. 3B illustrates a situation where write operations WR1 to WR4 on the zone blocks ZB1 to ZB4 progress respectively over time. Any or all of the zone blocks ZB1 to ZB4 may be empty, in which case the corresponding write operations may be initial write operations. Each of the write operations WR1 to WR4 may include data transmission and an internal operation. The data transmission may be an operation including transferring data from the controller 110 to any among the nonvolatile memory devices NM11, NM12, NM21 and NM22. The data may be transferred to a nonvolatile memory device including a memory region indicated by the start write pointer. The internal operation may include an operation of storing, by the nonvolatile memory device, data transferred from the controller 110 into the memory region indicated by the start write pointer.

As illustrated in FIG. 3A, the start write pointers of the zone blocks ZB1 and ZB2 may indicate memory regions in the groups GR1 and GR2, which are different from each other, and thus may indicate memory regions respectively coupled to the first input/output line IO1 and the second input/output line IO2, which are different from each other. Therefore, the write operations WR1 and WR2 respectively on the zone blocks ZB1 and ZB2 may be started at the same time. The controller 110 may start the write operations WR1 and WR2 respectively on the zone blocks ZB1 and ZB2 at the same time by simultaneously providing first data of the first write operation WR1 to the first input/output line IO1 and second data of the second write operation WR2 to the second input/output line IO2. More generally, the controller 110 may begin providing the first data to the first input/output line IO1, and may begin providing the second data to the second input/output line IO2 while the first data is still being provided. Consequently, the write operations WR1 and WR2 respectively on the zone blocks ZB1 and ZB2 may overlap each other.

The start write pointers of the zone blocks ZB1 and ZB3 may indicate memory regions of the same nonvolatile memory device NM11. In this case, between the zone blocks ZB1 and ZB3, after completion of the first write operation WR1 on the first zone block ZB1 (including completion of the internal operation of the first write operation WR1 within the nonvolatile memory device NM11), the controller 110 may start the third write operation WR3 on the zone block ZB3.

The start write pointers of the zone blocks ZB1 and ZB4 may respectively indicate memory regions of the nonvolatile memory devices NM11 and NM12, which are different from each other. However, the start write pointers of the zone blocks ZB1 and ZB4 may correspond to the same first group GR1 and thus may be coupled to the same first input/output line IO1. Therefore, the write operations WR1 and WR4 respectively on the zone blocks ZB1 and ZB4 may not be started at the same time, that is, the controller 110 may not overlap the providing of the respective write data of the write operations WR1 and WR4. In this case, after completion of data transmission TR1 to the first zone block ZB1 through the first input/output line IO1, the controller 110 may start the fourth write operation WR4 on the fourth zone block ZB4. Because the fourth write operation WR4 is not to the same nonvolatile memory device NM11 as the first write operation WR1, the controller 110 does not have to wait for the completion of the internal operation of the first write operation WR1 within the nonvolatile memory device NM11 before starting the fourth write operation WR4.

In summary, the write operations WR1 and WR2 respectively on two (i.e., a total number of the input/output lines IO1 and IO2) of the zone blocks ZB1 and ZB2 may be started at the same time. If the controller 110 is coupled to the storage medium 120 through N number of independent input/output lines, write operations on as many as N number of zone blocks may be started at the same time, or more generally the respective data transfer portions of write operations to up to N number of zone blacks may overlap in time. Therefore, the write performance of the memory system 100 may be improved.

In accordance with an embodiment, when the controller 110 initially starts writing data into empty zone blocks, the controller 110 may determine start write pointers of the zone blocks such that the start write pointers do not all correspond to the same group. For example, in order to start initial write operations on the zone blocks ZB1 and ZB3 at the same time when the start write pointer of the first block ZB1 corresponds to the first group GR1, the controller 110 may determine the start write pointer of the third zone block ZB3 such that the start write pointer of the third zone block ZB3 corresponds to the second group GR2, that is, such that the start write pointer of the third zone block ZB3 indicates a memory region of the memory block MB212 coupled to the input/output line IO2, which is different from the example provided in FIG. 3A. In an embodiment, the controller 110 may utilize start write pointers that are determined according to a number assigned to a zone block.

In an embodiment, a number of memory blocks used to provide storage for each zone block or a storage capacity of each zone block may be fixed even when increasing a number of nonvolatile memory devices coupled to the same input/output line in order to increase the storage capacity of the storage medium 120. That is, the controller 110 may manage zone blocks to have a constant size regardless of the storage capacity of the storage medium 120 and thus the memory system 110 may operate stably.

FIG. 4 is a diagram illustrating a data processing system 10 in accordance with an embodiment.

Referring to FIG. 4, the data processing system 10 may include a host device 11 and a memory system 12.

The host device 11 may provide the memory system 12 with a write request WRQ including zone block information ZBI. The host device 11 may designate a zone block, into which data is to be stored within a storage medium 220, through the zone block information ZBI. The zone block information ZBI may include a number or an address indicating a zone block.

In accordance with an embodiment, the host device 11 may designate a zone block within the storage medium 220 to store sequential data. The host device 11 may generate sequential data by merging random data and may designate a zone block to store such sequential data.

The memory system 12 may include a controller 210 and the storage medium 220. The controller 210 may write data into the zone block, which is designated by the zone block information ZBI within the storage medium 220, according to the write request WRQ. The controller 210 may configure and manage the zone block in substantially the same way as the controller 110 of FIG. 1. The storage medium 220 may be configured and may operate in substantially the same way as the storage medium 120 of FIG. 1. Therefore, a detailed description about the memory system 12 is omitted in the interest of brevity.

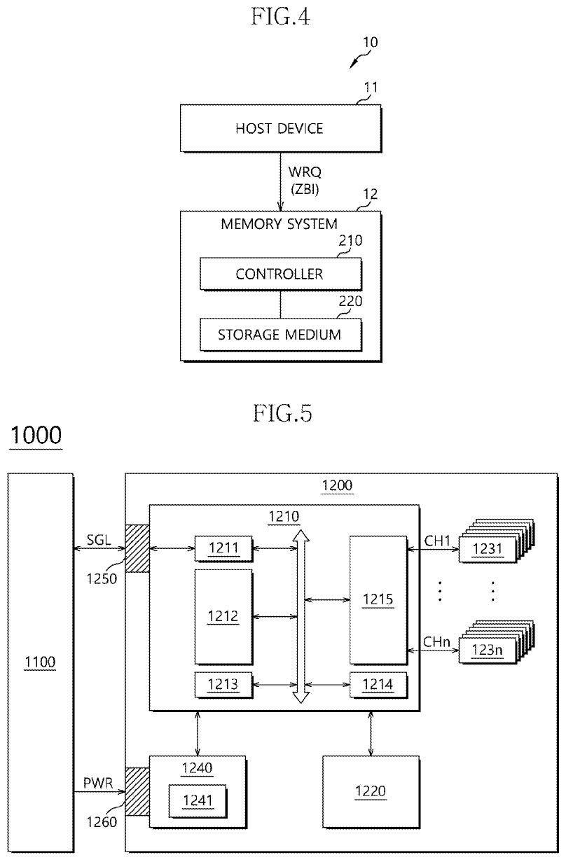

FIG. 5 is a diagram illustrating a data processing system 1000 including a solid state drive (SSD) 1200 in accordance with an embodiment. Referring to FIG. 5, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may be configured in the same manner as the controller 110 shown in FIG. 1. The controller 1210 may manage the plurality of nonvolatile memory devices 1231 to 123n by a unit of a zone block.

The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface the host device 1100 and the SSD 1200 according to the protocol of the host device 1100. For example, the host interface unit 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS).

The control unit 1212 may analyze and process the signal SGL received from the host device 1100. The control unit 1212 may control operations of internal function blocks according to a firmware or a software for driving the SSD 1200. The random access memory 1213 may be used as a working memory for driving such a firmware or software.

The ECC unit 1214 may generate the parity data of data to be transmitted to at least one of the nonvolatile memory devices 1231 to 123n. The generated parity data may be stored together with the data in the nonvolatile memory devices 1231 to 123n. The ECC unit 1214 may detect an error of the data read from at least one of the nonvolatile memory devices 1231 to 123n, based on the parity data. If a detected error is within a correctable range, the ECC unit 1214 may correct the detected error.

The memory interface unit 1215 may provide control signals such as commands and addresses to at least one of the nonvolatile memory devices 1231 to 123n, according to control of the control unit 1212. Moreover, the memory interface unit 1215 may exchange data with at least one of the nonvolatile memory devices 1231 to 123n, according to control of the control unit 1212. For example, the memory interface unit 1215 may provide the data stored in the buffer memory device 1220, to at least one of the nonvolatile memory devices 1231 to 123n, or provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus. The plurality of input/output lines and enable lines shown in FIG. 1 may respectively correspond to lines in the plurality of channels CH1 to CHn. For example, the enables lines EN11 and EN12 and the first input/output line IO1 may be lines in first channel CH1, and the enables lines EN21 and EN22 and the second input/output line IO2 may be lines in second channel. Accordingly, the first channel CH1 may correspond to the first group GR1, and the nth channel CHn may correspond to an nth group GRn.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

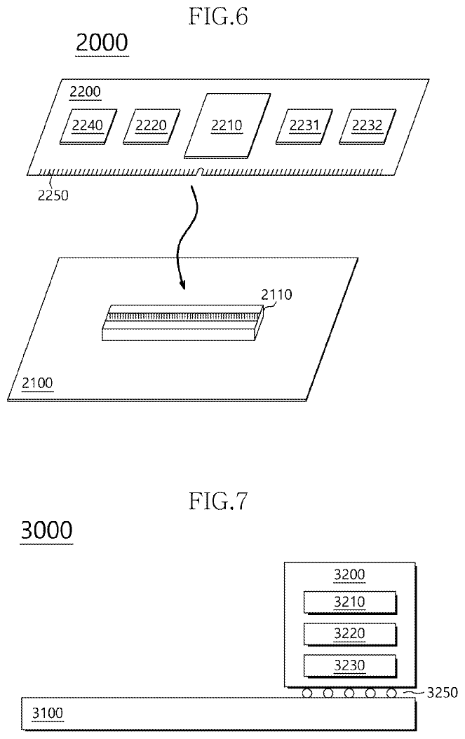

FIG. 6 is a diagram illustrating a data processing system 2000 including a memory system 2200 in accordance with an embodiment. Referring to FIG. 6, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot, or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 5.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

FIG. 7 is a diagram illustrating a data processing system 3000 including a memory system 3200 in accordance with an embodiment. Referring to FIG. 7, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 5.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

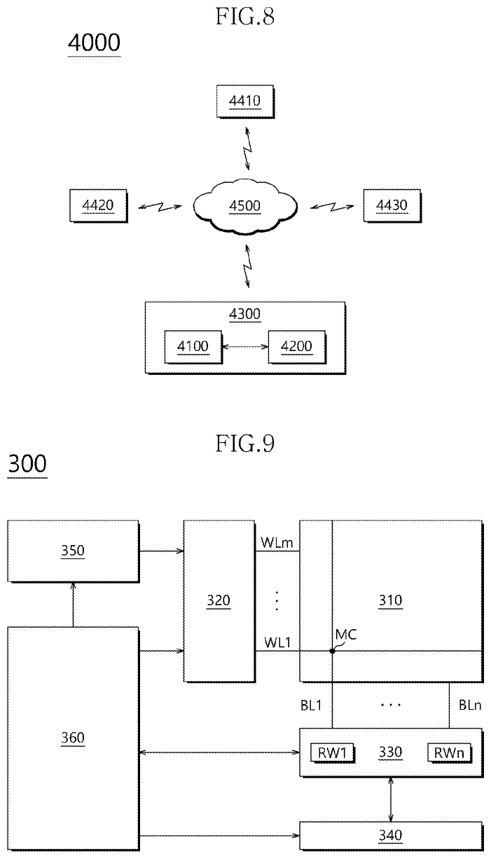

FIG. 8 is a diagram illustrating a network system 4000 including a memory system 4200 in accordance with an embodiment. Referring to FIG. 8, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the memory system 1200 shown in FIG. 6, the memory system 2200 shown in FIG. 7 or the memory system 3200 shown in FIG. 7.

FIG. 9 is a block diagram illustrating a nonvolatile memory device 300 included in a memory system in accordance with an embodiment. Referring to FIG. 9, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While certain embodiments have been described above, it will be understood to those skilled in the art that the embodiments described are by way of example only. Accordingly, the memory system and data processing system including the same should not be limited based on the described embodiments. Rather, the memory system and data processing system including the same described herein should only be limited in light of the claims that follow when taken in conjunction with the above description and accompanying drawings.

What is claimed is:

1. A memory system comprising:
a storage medium including a plurality of nonvolatile memory devices grouped into a plurality of groups; and
a controller configured to manage the storage medium by a unit of a zone block, the controller selecting one nonvolatile memory device from each of the groups and configuring the zone block over the selected nonvolatile memory devices.

2. The memory system of claim 1, wherein the controller is coupled to the plurality of nonvolatile memory devices respectively through enable lines that are different from one another, and selects nonvolatile memory devices coupled to enable lines of the same ordering within the respective groups in order to configure the zone block.

3. The memory system of claim 1, wherein the zone block is configured by memory blocks having the same block address within the selected nonvolatile memory devices.

4. The memory system of claim 1, wherein the controller manages a plurality of zone blocks in parallel, and
wherein the controller sets a first start write pointer corresponding to a first zone block of the plurality of zone blocks to indicate a first group of the plurality of groups, and sets a second start write pointer corresponding to a second zone block of the plurality of zone blocks to indicate a second group of the plurality of groups, the second group being different from the first group.

5. The memory system of claim 1, wherein nonvolatile memory devices included in the same group are all coupled to the controller through an input/output line coupled to no other group.

6. The memory system of claim 1, wherein the controller configures the zone block in order to write sequential data.

7. A memory system comprising:
a storage medium including a plurality of nonvolatile memory devices, the plurality of nonvolatile memory device including first and second nonvolatile memory devices respectively coupled to first and second input/output lines that are different from one another; and
a controller configured to manage the storage medium by a unit of a zone block, each zone block of a plurality of zone blocks being configured over each of the first and second nonvolatile memory devices, and
wherein the controller is further configured to perform a plurality of write operations respectively corresponding to the plurality of zone blocks at the same time.

8. The memory system of claim 7, wherein the controller performs the plurality of write operations at the same time by providing data to the plurality of zone blocks at the same time.

9. The memory system of claim 7,
wherein the plurality of nonvolatile memory devices are grouped into a plurality of groups,
wherein nonvolatile memory devices included in the same group are coupled to the controller through a same input/output line corresponding to that group, and
wherein for each of the plurality of zone blocks, the controller selects one respective nonvolatile memory device from each of the groups and configures that zone block over the selected nonvolatile memory devices.

10. The memory system of claim 9, wherein the controller respectively selects nonvolatile memory devices of the same ordering within the respective groups in order to configure each of the plurality of zone blocks.

11. The memory system of claim 9, wherein the controller is coupled to the plurality of nonvolatile memory devices respectively through enable lines that are different from one another, and selects nonvolatile memory devices coupled to enable lines of the same ordering within the respective groups.

12. The memory system of claim 7, wherein each of the plurality of zone blocks is configured to use memory blocks having the same block address within the nonvolatile memory devices respectively coupled to the enable lines that are different from one another.

13. A data processing system comprising:
a memory system including a storage medium and a controller; and
a host device configured to designate a zone block within the storage medium and provide a write request including information of the zone block to the controller,
wherein the controller writes data into the zone block according to the write request.

14. The data processing system of claim 13,
wherein the storage medium includes a plurality of nonvolatile memory devices grouped into a plurality of groups, and
wherein the controller selects one nonvolatile memory device from each of the groups and configures the zone block over the selected nonvolatile memory devices.

15. The data processing system of claim 14, wherein the controller is coupled to the plurality of nonvolatile memory devices respectively through a respective plurality of enable lines having respective orderings within each group, and selects nonvolatile memory devices coupled to enable lines of the same ordering within the respective groups in order to configure the zone block.

16. The data processing system of claim 14, wherein the zone block is configured by memory blocks having the same block address within the selected nonvolatile memory devices.

17. The data processing system of claim 14,
wherein the controller manages a plurality of zone blocks in parallel, and
wherein the controller sets a first start write pointer corresponding to a first zone block of the plurality of zone blocks to indicate a first group of the plurality of groups, and sets a second start write pointer corresponding to a second zone block of the plurality of zone blocks to indicate a second group of the plurality of groups that is different from the first group.

18. The data processing system of claim 14, wherein nonvolatile memory devices included in the same group are all coupled to the controller through an input/output line coupled to no other group.

19. The data processing system of claim 13, wherein the host device designates the zone block in order to write sequential data.
